(19) United States
(12) Patent Application Publication
(10) Pub. No.: US 2011/0309533 A1
(43) Pub. Date: Dec. 22, 2011

(54) Rotating surfaces for SDR

(76) Inventors: Florian Liesener, Trostberg (DE); Zhizhong Cai, Trostberg (DE); Jochen Mezger, Garching an der Alz (DE); Silke Flakus, Ebersberg (DE); Simone Klapdohr, Rosenheim (DE); Burkhard Walther, Garching (DE); Helmut Mack, Traunstein (DE); Tobias Austermann, Munster (DE)

(21) Appl. No.: 13/144,341

(22) PCT Filed: Dec. 11, 2009
(86) PCT No.: PCT/EP2009/066944

§ 371 Date: Aug. 9, 2011

(30) Foreign Application Priority Data
Jan. 13, 2009 (EP) 09150414.2

(51) Int. Cl. C07G 99/00; B01J 19/00

(52) U.S. Cl. 260/1; 422/187

(57) ABSTRACT

The proposed spinning disc reactor comprises substantially a horizontally rotatable, disc-like and thermostatable support element which has an outer reaction surface, feed means for feeding at least one reactant onto the reaction surface and internal structures for thermostating the reaction surface. In addition, it contains at least one separation apparatus for collecting and removing the reaction product from the reaction surface. The support element is characterized in particular in that it consists of two components a) and b) arranged horizontally one on top of the other and having substantially identical surface measures. These two components are connected to one another in an interlocking manner and tightly during the operating time and the lower component a) has, on its top facing the inner region of the support element, at least one substantially uninterrupted groove milled in over an extensive area and intended for receiving, conducting and discharging a heat-transfer fluid. In addition, it has at least two bores for feeding and discharging the heat-transfer fluid, at least one profiled seal encircling the outer surface region being arranged between the component a) and the component b). The two components a) and b) as a whole are reversibly connected to one another. As a result of such specific features, a simply designed reactor which is advantageous with respect to maintenance, is versatile and permits targeted control of the chemical reaction on its rotating surface is present.

The present invention relates to a so-called spinning disc reactor (“SDR”) and its use.

Spinning disc reactors, substantially comprising a disc-like and thermostatable support element arranged so as to be rotatable about a vertical axis and are thus capable of carrying out chemical reactions, are sufficiently well known from the prior art.

Thus, WO 00/48728 A1 describes a reactor having a support element which is rotatable about an axis, the support element having a surface and feed means connected thereto, by means of which at least one reactant can be applied to the surface. This reactor is equipped with a rotating impeller or a hot air blower, both of which are mounted so that they cover the surface of the support element and suck a gas-phase component from a region of the periphery surrounding the surface to the centre of the surface.

EP 1 156 875 B1 describes a reactor having a support element which is mounted so as to be rotatable about an axis and has a surface with a feed means for feeding at least one reactant to the surface of the support element and collecting means for collecting a product from the surface of the support element. The surface of the support element comprises an undercut notch into which at least one reactant is fed directly from the feed means during the use of the reactor; on rotation of the support element, the at least one reactant forms a substantially annular film within the at least one undercut notch and flows from there over the surface of the support element to the edge of the surface.

EP 1 169 125 B1 likewise describes a reactor apparatus having a support element designed to be rotatable about an axis. In this case, the support element has a surface with a circumference and a feed means for feeding at least one reactant to the surface. On rotation of the surface, a centrifugal force is produced so that the reactant flows as thin film freely over the surface and is spun off from the circumference thereof. This surface is substantially planar and furthermore a shear member which is in the form of a circumferential base surface of a dome or cap or in the form of a cylindrical or tubular member is provided, the shear member being arranged in the immediate vicinity of the surface but not mounted thereon. In this way, during use, it touches only the thin film at the point where it flows through between the circumferential base surface and the surface, and not at other points of the reaction surface.

U.S. Pat. No. 7,247,202 B1 describes a method for converting a substrate in a substantially fluid phase by heterogeneous contact of this substrate, or of a fragment or derivative thereof, with an agent in a substantially solid phase. The solid-phase reagent is present as a surface of a support element, the support element being designed so that it rotates about an axis in a manner such that the solid-phase agent provides a rotating surface or a part thereof and the substrate provides a film which flows substantially radially from the axis outwards and in dynamic contact with the agent. In addition, a vibration energy, which is preferably ultrasound, is supplied to the substrate.

According to EP 1 152 824 B2, a reactor apparatus is provided with a hollow support element. This is rotatable about an axis, the support element having a first outer surface for reaction, second inner surface for heat transfer and a device for treating the second surface with a heat-transfer fluid. The first and the second surfaces are dynamically connected to one another and the support element has an interior which is bounded on one side by the second surface. Moreover, the support element has a feed device for treating the first outer reaction surface with a reactant in liquid, gaseous or solid phase, the interior of the hollow support element being provided with a plate or membrane which extends substantially over the total interior. In this way, a first space forms between the second surface and one side of the plate or membrane, and a second space forms between an opposite side of the plate or membrane and an inner surface of the support element, which inner surface is removed from the second surface. However, it is essential for a gap to remain at the circumference of the plate or the membrane so that heat-transfer fluid can flow between the first and the second space, the opposite plate or membrane being provided with a net, a woven fabric or a foam in order in this way to prevent the formation of free vortices in the heat-transfer fluid.

The use of such spinning disc reactors is described, for example, in the documents WO 03/008083 A1 and WO 03/008460 A1: in the first case, a method for the production of particles is described, first a solution with at least one predetermined substance being fed to a rotating surface of a rotation reactor. Thereafter, this solution spreads over the rotating surface in the form of an uninterrupted flowing and thin film, followed by precipitation or crystallization of particles from the solution by means of micromixing and homogeneous nucleation. Finally, the precipitated or crystallized particles are collected in the periphery of the rotating surface.

In the second case, the use of a rotating surface reactor serves for controlling biomolecular termination reactions in polymerization reactions. In this case, chemical constituents are polymerized by virtue of the fact that they move in a thin film over a surface which rotates about an axis of rotation, the thin film flowing from an inner region to an outer region of the surface and being removed therefrom. In this way, polymer chains are formed in the thin film and stimulated to grow. The surface is rotated in such a way that the polymer chains are caused to unwind and/or to extend over the surface in directions which run radially away from the axis of rotation, in order thus to reduce a translational and/or segment-by-segment diffusion of active polymer chains and thus to reduce biomolecular termination reactions.

Since such spinning disc reactors are suitable in particular for mass-transfer and heat-transfer reactions, there have of course also been approaches with the aim of making spinning disc reactors even more suitable for such reactions. The substantial aspect has concentrated on the transfer of reaction energy to the reaction surface and in particular on the use of heat-transfer fluids. Thus, for example, WO 2006/008500 A1 describes a reactor, including a support element, this support element in turn being arranged so as to be rotatable about an axis and having a first surface which is generally centred on the axis. The first surface is adapted to an outward radial flow of a thin film of a liquid colour reactant which, in the case of the rotation of the support element, flows away over the support element after its application thereto. Furthermore, a second surface is comprised, which is arranged opposite to the first surface and exchanges heat with the first surface. The second surface is provided with a spiral passage which is generally centred on the axis. The second surface has apparatuses for feeding a heat-transfer fluid to the spiral passage.

WO 2004/004888 A1 describes a similar reactor. Its at least one support element has a spiral configuration with an inner and an outer surface. The support element is once again arranged so as to be rotatable about an axis in such a way that the inner surface faces the axis of rotation. Moreover, the support element should be equipped with means for heat transfer to or from the inner surface.

A further variant for exchange between inner and outer surfaces of a support element forms the subject according to WO 2006/040566 A1. The spinning disc reactor described there has a support element with a centred surface and an inner surface opposite to the exposed external surface. This exposed surface is designed so that a thin film of a liquid phase migrates to the outer edge of the surface when it is applied to the rotating surface. At least a part of the support element should be permeable or semipermeable or porous in order thus to permit a liquid or gas phase to pass between the outer and inner surface but to prevent the passage of particles in the μm range.

Finally, an entirely hollow support element of a spinning disc reactor according to WO 2006/018622 A1 has a second inner surface for heat exchange. In addition, the hollow support element has, in its interior, a plate or a membrane which extends substantially over the inner space and forms a flow-through gap in order to enable the heat-transfer fluid to flow through between the different spaces. At least one of the plates or membranes of the second surface is shaped or profiled in such a way that the distance between one side of the plate or membrane and the second surface varies along the radius and starting from the axis.

All spinning disc reactors of the prior art and in particular the variants just described in more detail have the disadvantage that they are expensive to produce, to operate and to maintain. Moreover, the specific devices for feeding, transporting and removing heat-transfer fluids are complex and susceptible to faults.

For this reason, it was the object of the present invention to develop a reactor which, according to the prior art, has a disc-like and thermostatable support element arranged so as to be rotatable about a centrally arranged and substantially vertical axis. This support element has an outer reaction surface, feed means for feeding at least one reactant onto the reaction surface and internal structures for thermostating the reaction surface. Moreover, this reactor has at least one separation apparatus for collecting and removing the reaction production from the reaction surface. The further development of a reactor designed in this manner should simplify the use of a heat-transfer fluid and in particular permit easier production of a spinning disc reactor. In particular, it has been shown that the reactor has complete tightness with respect to the heat-transfer fluid during its operating time and that the heat-transfer fluid is transported so that the reaction surface ensures the respective desired reaction temperature uniformly and permanently during the reaction time. Of course, economic aspects would have to be taken into account in the production, the operation and the maintenance of the reactor.

This object is achieved with the aid of a reactor in which the support element consists of two components a) and b) arranged horizontally one on top of the other and having substantially identical surface measures. The two components a) and b) are connected to one another in an interlocking manner and tightly during the operating time of the reactor, the lower component a) having, on its top (1) facing the inner region of the support element, at least one substantially uninterrupted groove (2) milled in over an extensive area and intended for receiving, transporting and discharging a heat-transfer fluid, and at least two bores (3) for feeding and discharging the heat-transfer fluid, at least one profiled seal (4) encircling the outer surface region being arranged between the component a) and component b), and the two components a) and b) being reversibly connected to one another.

With the use of the spinning disc reactor according to the invention, it has surprisingly been found that not only does it enable the object to be completely achieved but that, particularly owing to the simplified transport of the heat-transfer fluid, it is possible to carry out chemical reactions which require fine tuning of the heat transfer. The advantage is also evident with regard to the effect of the reaction products and with respect to their physical properties, in particular in the production of particles. In contrast to the prior art to date and in particular to the apparatus according to WO 2006/008500 A1, the reactor according to the invention is distinguished in particular by its simple design. According to the closest prior art, the support element in fact consists of two parts which are firmly connected to one another and arranged one on top of the other and which have a cavity between them. As already stated, the lower part has, on its underside, two uniformly arranged and spiral webs which lead from the midpoint of the disc to the edge region. Two holes which are directed in the direction of the rotor axis and through which a liquid can be passed in and out of the cavity are present in the centre of the disc. The underside of the upper part of the disc has a spiral arrangement arranged in a complementary manner so that the two spirals of the upper and of the lower part of the disc engage one another. Owing to the resulting spaces of these two double spirals, the heat-transfer liquid is passed from the midpoint of the disc to the edge of the disc and back so that it is possible to cool or to heat the disc. The disc geometry described according to the prior art leads to the support element consisting of a single component. If this component has to be adapted to another reaction programme, when it is necessary, for example, due to changed materials, contours and coatings of the surfaces, the entire support element must be newly constructed. Moreover, the described construction according to the prior art has a very complex design since the lower and the upper parts have a complicated structure in their interior.

In comparison, the reactor according to the present invention, owing to its surprisingly simple construction features, permits a flexible adaptation with respect to the required material, the reaction surface, its contour, but also possibly helpful coatings. In this way, it is possible to meet a very wide range of requirements which are made necessary by the respective chemical and physical reactions, without great effort, since usually in each case only the component b), i.e. the upper part, has to be adapted on its outside, which represents the reaction surface. Moreover, in the case of operating faults, the support element can be maintained without great effort. The advantages of these improvements were not to be foreseen in their extent.

As already indicated, the reactor according to the invention is distinguished in particular in that it can be adapted in a flexible manner to the respective requirements. For this reason, the present invention also provides a variant in which the lower component a) is produced from metal, a plastic or a ceramic. Preferably, the lower component consists of metal, all mixtures of said materials of course also being suitable. A similar range of variation relates to the upper component b). This can likewise be produced from metal, a plastic or a ceramic, in which case glass is also suitable. Here too, however, metal is once again to be regarded as being preferred as a construction material.

The use of the proposed reactor is not limited to any specific areas since the actual invention relates to the improved reception, transport and discharge of a heat-transfer fluid in the interior of the support element. The construction feature essential to the invention is independent of the outer reaction surface of the support element, so that this, as a substantial part of the upper component b), can be made smooth, fluted, corrugated and/or concave or convex. In this way, the reaction programme can be controlled in a targeted manner and the reaction behaviour of the reactants added to the reaction surface can be influenced. Owing to the respective surface structure, which of course will also differ on one and the same reaction surface by mixing or alternating different structures, there are different residence times on the reaction surface, which are also based on different migration rates over the surface to the edge of the disc. Of course, the different design elements of the reaction surface also serve for homogeneous mixing of the reactants in the reaction film.

In addition, but also independently of the respective structural configuration of the reaction surface, the present invention ensures that the outer reaction surface is at least partly coated. Preferably, this coating consists of a heat-conducting and/or an inert and temperature-resistant material and in particular of a polymer, such as, for example a polymeric, halogenated, unsaturated hydrocarbon and preferably a polymeric tetrafluoroethylene. This results in additionally improved reaction behaviour of the reactants used on the reaction surface and the design and structural deviations on the reaction surface can be compensated in this way. Of course, the reaction surface as a whole, but also only specific areas or sections, can additionally, but also independently of additional coatings, be provided with further components, i.e. for example, components having catalytic capabilities.

As already indicated several times, the main aspect of the invention, essential to the invention, consists in the internal configuration of the support elements. In this context, the present invention takes into account a variant in which the two surfaces of the components a) and b) which face one another, i.e. the two surfaces in the interior of the support element, have a region with a predominantly smooth transition and are preferably in surface contact with one another in their totality, with the exception of the groove region (2).

Regarding the groove (2), the present invention takes into account design variants in which the groove runs in a spiral, annular and/or meandering manner in the surface (1) of the lower component or is present in the form of at least two concentrically arranged grooves. In the last-mentioned case, the grooves are then connected to one another by at least one radial groove. In each case, the groove is or the grooves are to be arranged so that the heat-transfer fluid uniformly heats or cools the reaction surface of the component b).

The present invention therefore substantially consists in the fact that the surface which faces the reaction surface of the upper component b) and which at the same time forms the upper part of the interior of the support element has a smooth surface and that the top (1) of the lower component a), which at the same time forms the lower part of the interior of the support element, has at least one groove (2) milled into it. If the upper component b) is mounted on the lower component a), the result is a contact with a smooth transition between the respective inner surfaces, with the exception of the groove region. In the cavity of the groove(s) which thus remains, the heat-transfer fluid can be fed in, transported and discharged.

Another substantial aspect is in the form of at least two bores (3) of the lower component a) which serve for feeding and discharging the heat-transfer fluid. Preferably, these at least two bores (3) should be arranged centrally and adjacent to the axis. In this way, the heat-transfer fluid can be fed in a simple manner via an apparatus which is coupled to the axis of rotation to the interior of the support element and can be removed therefrom.

However, it is also possible for at least one of the at least two bores for feeding and discharging the heat-transfer fluid to be arranged centrally and adjacent to the axis and the other at least one bore to be arranged peripherally at the edge of the surface of the support element. The minimum distance between the bores in the central and peripheral region thus corresponds as a rule to the radius of the support element. Since the support element is arranged so that it rotates horizontally in the surface, the heat-transfer fluid is in this case always fed in centrally and discharged in the peripheral region. The transport and direction of flow of the heat-transfer fluid are always dependent on the rotational velocity of the support element and the resulting centrifugal force in its interior. The vertical axis of the support element can, if required, also deviate from the perpendicular or the axis itself can describe the lateral surface of a cone during the rotation, so that there is a tumbling movement of the support element.

The present invention also covers the possibility of connecting the two components a) and b) firmly to one another, at least during the operating time, by clasps, clamps, bolts, threaded rods or magnets. Of course, all further possibilities can also be considered for connecting the upper and the lower component of the support element to one another in an interlocking and tight manner. Here, for example, bayonet fittings or milled threads are also conceivable. Bolts (5) are particularly suitable.

A further feature essential to the invention consists in the tight connection of the upper and lower components, which is important in particular during the rotation of the support element, i.e. during the actual reaction time. In order to ensure this sealing or additionally to increase it, the present invention provides at least one profiled seal (4). This should run in an annular groove in the peripheral region of the component a) and/or b). This groove, like the groove for conducting the heat-transfer fluid, can likewise be milled in or can be ensured also by the combination of the lower and/or upper component with an indentation to run in the peripheral region of the respective components. The profiled seal discussed may be of any possible configuration. Thus, its cross section can be circular, polygonal or oval but also flat as a whole. In most cases, said seal will be a typical compressible seal in order thus to ensure to a maximum extent the desired sealing effect. Of course, a plurality of even differently shaped and designed annular seals can be combined with one another.

Both gases and liquids are suitable as heat-transfer fluid; however, it is also possible to use solids if their particles have macroscopic flow properties. Typically, water or steam but also oils are used. In general, liquids having advantageous freezing and boiling points and corresponding specific heat capacities are especially suitable.

The rotating surface of the support element gives rise to centrifugal forces which result in the formation of a reaction film on the rotating surface. Depending on the rotational velocity and the viscosity of the starting reactants and of the reaction product, the film moves to the outside of the surface, where it is spun off the surface. For collecting and removing the resulting reaction product from the reaction surface, the claimed reactor has a corresponding apparatus which, in the simplest case, consists of a vertical wall which completely surrounds the support element in a circular arrangement and at a tailored distance. This wall can be adapted in its temperature to the respective method so that it can be either heated or cooled. In most cases of an increased reaction temperature on the rotating surface, the collecting wall is cooled so that the reaction product spun off condenses on the perpendicular wall and, depending on its viscosity, runs off under gravitational force and can be collected in a collecting apparatus, for example in the form of a channel. The reaction product can finally be removed from this channel. Of course, it is also possible to influence the vertical wall so that a reaction product adhering to it is fed to the collecting apparatus more rapidly and without forming residues. In particular, gentle and continuous vibration of the impact wall, which can be effective, for example, mechanically but also by ultrasound, is suitable for this purpose. The central reaction axis with the horizontal support element surrounding it and the collecting apparatus encircling the support element result in a substantially compact potential construction for the spinning disc reactor. Thus, the discharge apparatus (discharge channel) in the lower region of the construction can form the base of the reactor and a cover which can be adapted in its shape and its material to the respective requirements can be mounted on the vertical collecting wall mounted in a circular manner.

In addition to the reactor itself, the present invention comprises the use thereof. This is not subject to any special limitation overall since the claimed spinning disc reactor substantially follows the design variants of the prior art and differs radically therefrom only with regard to the inner region of the support element. The reactor according to the invention is therefore used primarily for carrying out reactions with participating mass-transfer and/or heat-transfer processes. Preferably, at least two reactants are applied to the reaction surface of the support element. These should advantageously be present in each case in liquid form. In this case, the respective viscosities of the reactants involved can of course be varied. The respective reactants can react with one another and lead to desired products. One of the reactants can, however, also be used for removing impurities from the other reactant.

The reaction temperature too, is substantially subject to no limits. According to the invention, however, the reaction temperature on the reaction surface of the support element should be adjusted to temperatures between −50° C. and 250° C. with the aid of the heat-transfer fluid. Preferred ranges are between −20 and 220° C. and in particular between 0 and 200° C. A range between 10 and 150° C. is likely to be suitable for most reactions, and it is for this reason that this range is also to be recorded as being particularly preferred.

The proposed reactor is also suitable for a broad range of rotational speeds: thus, the support element should rotate, at least during the reaction time, at a speed of 50 to 2500 revolutions per minute. Preferred rotational speeds are between 200 and 2000, in particular between 400 and 1700 and particularly preferably between 800 and 1500 revolutions per minute. In said ranges, a very wide range of chemical reactions, but also changes of physical properties, for example with regard to the particle size, can be carried out. Thus, the claimed reactor is suitable in particular for the preparation of polyurethanes, but also for the derivatization thereof and for the purification of starting compounds and products.

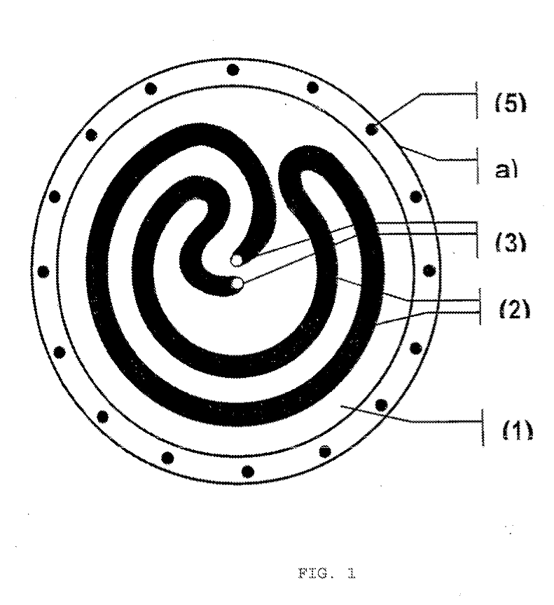

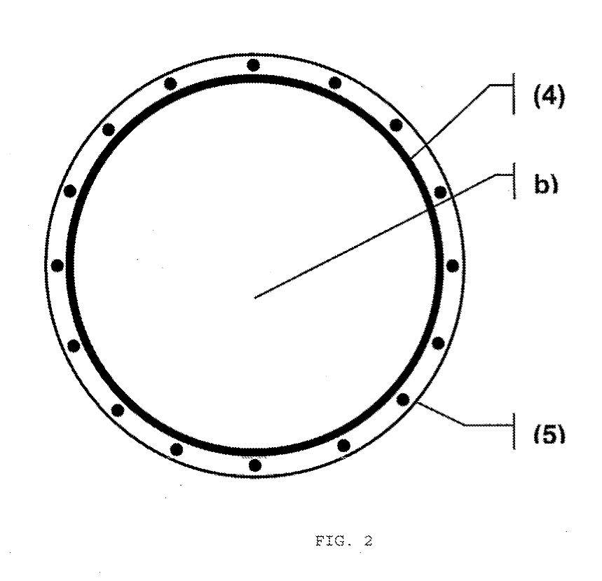

FIGS. 1 and 2 show, by way of example, an embodiment of the support element according to the invention with its two components a) and b). The two bores (3) are arranged in a centred manner; the components a) and b) are sealed by means of an annular and all-round profiled seal (4). The components a) and b) are connected via bolts (5) which are passed through all-round openings in at least one of the components a) and b) and secured on the outside.

1-15. (canceled)

16. A reactor comprising
a disc-like and thermostatable support element arranged so as to be rotatable about a centrally arranged and substantially vertical axis and which has an outer reaction surface;
feed means for feeding at least one reactant onto the reaction surface and internal structures for thermo stating the reaction surface; and
at least one separation apparatus for collecting and removing the reaction product from the reaction surface;
wherein the support element comprises two components a) and b) arranged horizontally one on top of the other and having substantially identical surface measures, which are connected to one another in an interlocking manner and tightly during the operating time, the lower component a) having, on its top facing the inner region of the support element; at least one substantially uninterrupted groove milled in over an extensive area and intended for receiving, transporting and discharging a heat-transfer fluid and at least two bores for feeding and discharging the heat-transfer fluid; at least one profiled seal encircling the outer surface region being arranged between the component a) and the component b), and the two components a) and b) being reversibly connected to one another.

17. A reactor according to claim 16, wherein the lower component a) consists of metal, a plastic or a ceramic and preferably of metal.

18. A reactor according to claim 16, wherein the upper component b) comprises at least one member selected from the group consisting of metal, glass, a plastic and a ceramic.

19. A reactor according to claim 17, wherein the upper component b) comprises at least one member selected from the group consisting of a metal, glass, a plastic and a ceramic.

20. A reactor according to claim 16, wherein the upper component b) comprises a metal.

21. A reactor according to claim 16, wherein the upper component b) comprises a metal.

22. A reactor according to claim 16, wherein the outer reaction surface of the upper component b) is smooth, fluted, corrugated, concave, convex or has regions formed in such a manner or mixed forms thereof.

23. A reactor according to claim 16, wherein the outer reaction surface is at least partly coated, preferably with a heat-conducting or an inert and temperature-resistant polymer, such as, for example, a polymeric halogenated unsaturated hydrocarbon and in particular with a polymeric tetrafluoroethylene.

24. A reactor according to claim 16, wherein those two surfaces of the components a) and b) which face one another have at least one region of the smooth transition and are preferably in surface contact with one another in their totality with the exception of the groove region.

25. A reactor according to claim 16, wherein the at least one groove is milled in a spiral, annular or meandering manner into the top of the component a) or is present in the form of at least two concentrically arranged grooves which are then connected by at least one radial groove.

26. A reactor according to claim 16, wherein the at least two bores of the component a) for feeding and discharging the heat-transfer fluid are arranged centrally and adjacent to the axis.

27. A reactor according to claim 16, wherein at least one of the at least two bores for feeding and discharging the heat-transfer fluid is arranged centrally and adjacent to the axis and the other at least one bore is arranged peripherally at the edge of the surface.

28. A reactor according to claim 16, wherein the components a) and b) are connected to one another by clasps, clamps, bolts, threaded rods or magnets during the operating time.

29. A reactor according to claim 16, wherein the at least one profiled seal runs in an annular groove of the component a) and/or b).

30. A process comprising conducting a reaction with participating mass transfer or heat-transfer processes with the reactor according to claim 16.

31. The process of claim 30, wherein at least two reactants are applied to the reaction surface of the support element.

32. The process of claim 31, wherein said at least two reactants are liquids.

33. The process of claim 30, wherein the reaction temperature on the reaction surface of the support element is adjusted to a temperature between −50° C. and 250° C. with the aid of the heat-transfer fluid.

34. The process according to claim 30, wherein the support element rotates at a speed of 50 to 2500 revolutions per minute during the reaction.
